(19) United States
(12) Patent Application Publication
(10) Pub. No.: US 2020/0122554 A1
(43) Pub. Date: Apr. 23, 2020

(54) AUTOMOTIVE HUMIDIFYING ASSEMBLY

(71) Applicants: Gerald Raymond, Maple Lake, MN (US); Arylene Raymond, Maple Lake, MN (US)

(72) Inventors: Gerald Raymond, Maple Lake, MN (US); Arylene Raymond, Maple Lake, MN (US)

(21) Appl. No.: 16/162,985

(22) Filed: Oct. 17, 2018

(51) Int. Cl. B60H 3/02

(52) U.S. Cl. CPC B60H 3/022; F24F 2006/146; B60H 2003/026

(57) ABSTRACT

A automotive humidifying assembly includes a housing that can be gripped by a user during automotive travel and the housing has a vapor aperture extending therein. A reservoir is provided that contains a fluid and the reservoir is removably coupled to the housing. A pump is positioned within the housing and the reservoir is placed in fluid communication with the pump when the reservoir is positioned in the housing. An atomizer is positioned within the housing and the atomizer converts the fluid in the reservoir into a vapor when the pump is turned on. Thus, the vapor aperture releases the vapor for moistening the user's eyes. A funnel is coupled to the housing and the funnel is in fluid communication with the vapor aperture. The funnel can be positioned proximate one of the user's eyes for directing the vapor into the user's eye thereby facilitating the user's eye to be moistened.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to humidifying devices and more particularly pertains to a new humidifying device for humidifying a user's eyes during automotive travel.

### BRIEF SUMMARY OF THE INVENTION

An embodiment of the disclosure meets the needs presented above by generally comprising a housing that can be gripped by a user during automotive travel and the housing has a vapor aperture extending therein. A reservoir is provided that contains a fluid and the reservoir is removably coupled to the housing. A pump is positioned within the housing and the reservoir is placed in fluid communication with the pump when the reservoir is positioned in the housing. An atomizer is positioned within the housing and the atomizer converts the fluid in the reservoir into a vapor when the pump is turned on. Thus, the vapor aperture releases the vapor for moistening the user's eyes. A funnel is coupled to the housing and the funnel is in fluid communication with the vapor aperture. The funnel can be positioned proximate one of the user's eyes for directing the vapor into the user's eye thereby facilitating the user's eye to be moistened.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an automotive humidifying assembly according to an embodiment of the disclosure.

FIG. 2 is a bottom view of an embodiment of the disclosure.

FIG. 3 is a left side exploded view of an embodiment of the disclosure.

FIG. 4 is a front view of an embodiment of the disclosure.

FIG. 5 is a cross sectional view taken along line 5-5 of FIG. 4 of an embodiment of the disclosure.

### DETAILED DESCRIPTION OF THE INVENTION

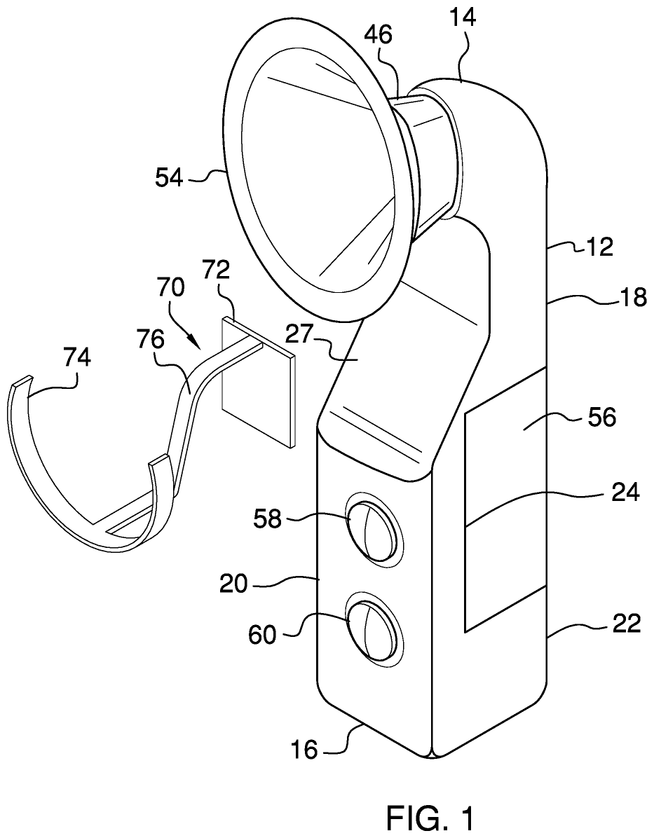

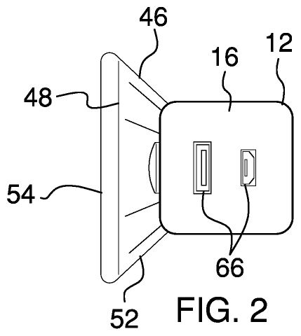

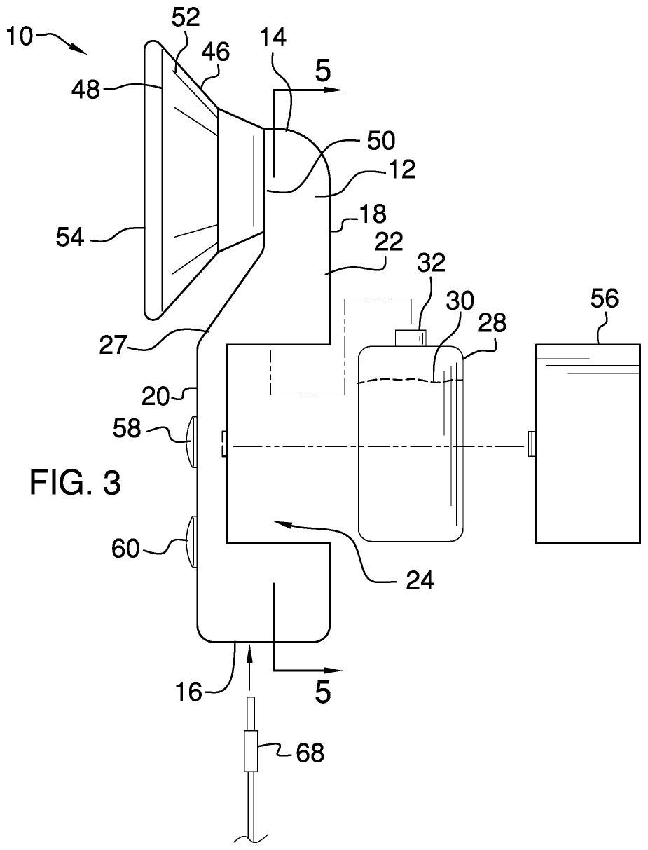

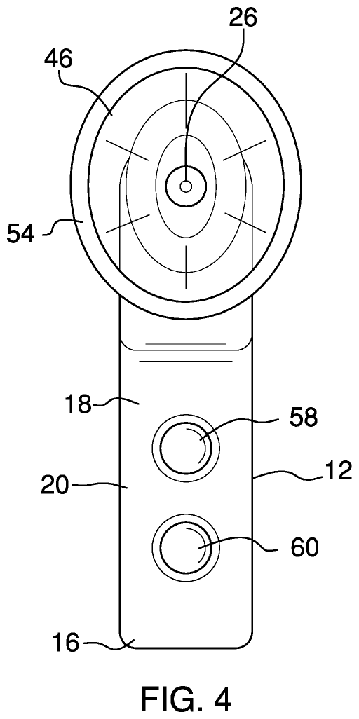

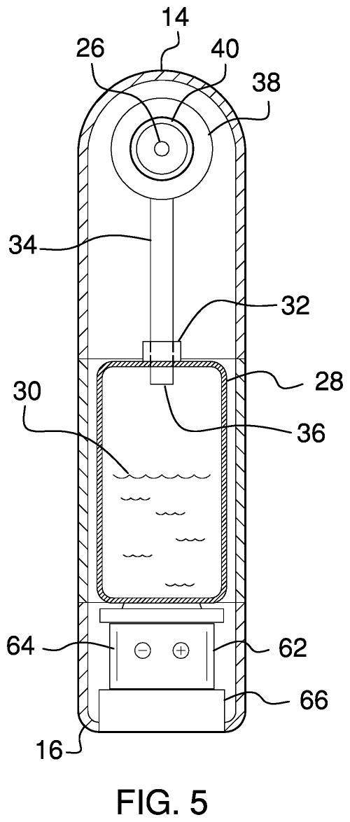

With reference now to the drawings, and in particular to FIGS. 1 through 5 thereof, a new humidifying device embodying the principles and concepts of an embodiment of the disclosure and generally designated by the reference numeral 10 will be described.

As best illustrated in FIGS. 1 through 5, the automotive humidifying assembly 10 generally comprises a housing 12 that may be gripped by a user during automotive travel. The housing 12 has a diameter that is sufficiently small to fit within cup holders commonly found in an automobile for storage. The housing 12 has a first end 14, a second end 16 and an outer wall 18 extending therebetween, and the outer wall 18 has a front side 20 and a back side 22. The back side 22 has a well 24 extending inwardly toward the front side 20 and the front side 20 has a vapor aperture 26 extending into an interior of the housing 12. The vapor aperture 26 is positioned closer to the first end 14 than the second end 16, and the well 24 is positioned closer to the second end 16 than the first end 14. The front side 20 of the outer wall 18 has an angled portion 27 extending between a center of the housing 12 and the first end 14. Thus, the first end 14 has a diameter that is less than a diameter of the second end 13

A reservoir 28 is included that contains a fluid 30, such as water or other fluid that is non-toxic to the human eye. The reservoir 28 is removably positioned in the well 24 and the reservoir 28 has an outlet 32. The outlet 32 is removably coupled to the reservoir 28 for filling the reservoir 28 with the fluid 30. A pump 34 is positioned within the housing 12, and the pump 34 has an input 36 and an output 38. The outlet 32 on the reservoir 28 is placed in fluid communication with the input 36 when the reservoir 28 is positioned in the well 24. In this way the pump 34 can draw the fluid out of the reservoir 28 when the pump 34 is turned on. The pump 34 may be an electric fluid pump 34 or the like.

An atomizer 40 is positioned within the housing 12 and the atomizer 40 is fluidly coupled between the output 38 of the pump 34 and the vapor aperture 26. The atomizer 40 converts the fluid 30 in the reservoir 28 into a vapor 42 when the pump 34 is turned on. In this way the vapor aperture 26 can release the vapor 42 for moistening the user's eyes 44. The atomizer 40 may be a fluid atomizer 40 of any conventional design commonly associated with household humidifiers or the like.

A funnel 46 is coupled to the housing 12 and the funnel 46 is in fluid communication with the vapor aperture 26. The funnel 46 has a front end 48, a back end 50 and an outside wall 52 extending therebetween, and the outside wall 52 flares outwardly between the back end 50 and the front end 48. The back end 50 is coupled to the front side 20 of the outer wall 18 of the housing 12 having the back end 50 being aligned with the vapor aperture 26. The front end 48 can be positioned proximate one of the user's eyes for directing the vapor 42 into the user's eye thereby facilitating the user's eye to be moistened. A cushion 54 is coupled to and is coextensive with the front end 48 of the funnel 46 for enhancing comfort for the user. Additionally, the outside wall 52 of the funnel 46 may be comprised of a translucent material.

A cover 56 is removably coupled to the housing 12 for enclosing the reservoir 28. The cover 56 is aligned with the well 24 when the cover 56 is removably coupled to the housing 12. An on button 58 is movably coupled to the housing 12 and the on button 58 is electrically coupled to the pump 34 for turning the pump 34 on. An off button 60 is movably coupled to the housing 12 and the off button 60 is electrically coupled to the pump 34 for tuning the pump 34 off.

A power supply 62 is removably positioned within the housing 12 and the power supply 62 is electrically coupled to the pump 34. The power supply 62 comprises at least one battery 64 and a plurality of charge ports 66. Each of the charge ports 66 is electrically coupled to the at least one battery 64 and the charge ports 66 are recessed into the second end 16 of the housing 12. The plurality of charge ports 66 can be electrically coupled to a power source 68 for charging the battery 64, and the plurality of charge ports 66 may include a usb port and a micro usb port.

A support 70 is provided that has a plate 72, a saddle 74 and a member 76 extending between the plate 72 and the saddle 74. The plate 72 may include an adhesive for adhesively engaging a surface in the automobile. The housing 12 can be placed in the saddle 74 for storage in a vehicle that does not have a cup holder. The member 76 may undulate downwardly between the plate 72 and the saddle 74 to inhibit the funnel 46 from contacting the member 76 when the housing 12 is positioned in the saddle 74.

In use, the reservoir 28 is filled with the fluid 30, the reservoir 28 is positioned in the well 24 and the cover 56 is coupled to the housing 12 to close the well 24. The housing 12 is gripped and the on button 58 is manipulated to turn the pump 34 on and thusly urge the vapor 42 outwardly through the funnel 46. The funnel 46 is directed toward one of the user's eyes to direct the vapor 42 onto the user's eye thereby moistening the user's eye. In this way an individual that suffers from a dry eye condition can relieve symptoms of the dry eye condition during automotive travel. Thus, dry eye conditions that may be caused by heating and air conditioning systems in an automobile can be treated without having to turn off the heating and air conditioning system in the automobile.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automotive humidifying assembly being configured to release vaporized water toward a user's eyes when the user is driving an automobile, said assembly comprising:
a housing being gripped by a user during automotive travel, said housing having a vapor aperture extending therein;
a reservoir containing a fluid, said reservoir being removably coupled to said housing;
a pump being positioned within said housing, said reservoir being placed in fluid communication with said pump when said reservoir is positioned in said housing;
an atomizer being positioned within said housing, said atomizer converting the fluid in said reservoir into a vapor when said pump is turned on thereby facilitating said vapor aperture to release the vapor for moistening the user's eyes; and
a funnel being coupled to said housing, said funnel being in fluid communication with said vapor aperture, said funnel being configured to be positioned proximate one of the user's eyes for directing the vapor into the user's eye thereby facilitating the user's eye to be moistened.

2. The assembly according to claim 1, wherein said housing has a first end, a second end and an outer wall extending therebetween, said outer wall having a front side and a back side, said back side having a well extending inwardly toward said front side, said vapor aperture extending through said front side into an interior of said housing, said vapor aperture being positioned closer to said first end than said second end, said well being positioned closer to said second end than said first end.

3. The assembly according to claim 2, wherein:
said reservoir is removably positioned in said well, said reservoir having an outlet; and
said pump has an input and an output, said outlet on said reservoir being placed in fluid communication with said input when said reservoir is positioned in said well, said output on said pump being fluidly coupled to said vapor aperture.

4. The assembly according to claim 3, wherein said funnel has a front end, a back end and an outside wall extending therebetween, said outside wall flaring outwardly between said back end and said front end, said back end being coupled to said front side of said outer wall of said housing having said back end being aligned with said vapor aperture.

5. The assembly according to claim 2, further comprising a cover being removably coupled to said housing for enclosing said reservoir, said cover being aligned with said well when said cover is removably coupled to said housing.

6. The assembly according to claim 2, further comprising:
an on button being movably coupled to said housing, said on button being electrically coupled to said pump for turning said pump on; and
an off button being movably coupled to said housing, said off button being electrically coupled to said pump for tuning said pump off.

7. The assembly according to claim 6, further comprising a power supply being removably positioned within said housing, said power supply being electrically coupled to said pump, said power supply comprising at least one battery.

8. An automotive humidifying assembly being configured to release vaporized water toward a user's eyes when the user is driving an automobile, said assembly comprising:
a housing being gripped by a user during automotive travel, said housing having a first end, a second end and an outer wall extending therebetween, said outer wall having a front side and a back side, said back side having a well extending inwardly toward said front side, said front side having a vapor aperture extending into an interior of said housing, said vapor aperture being positioned closer to said first end than said second end, said well being positioned closer to said second end than said first end;
a reservoir containing a fluid, said reservoir being removably coupled to said housing, said reservoir being removably positioned in said well, said reservoir having an outlet;
a pump being positioned within said housing, said pump having an input and an output, said outlet on said reservoir being placed in fluid communication with said input when said reservoir is positioned in said well thereby facilitating said pump to draw the fluid out of said reservoir when said pump is turned on;
an atomizer being positioned within said housing, said atomizer being fluidly coupled between said output of said pump and said vapor aperture, said atomizer converting the fluid in said reservoir into a vapor when said pump is turned on thereby facilitating said vapor aperture to release the vapor for moistening the user's eyes;
a funnel being coupled to said housing, said funnel being in fluid communication with said vapor aperture, said funnel having a front end, a back end and an outside wall extending therebetween, said outside wall flaring outwardly between said back end and said front end, said back end being coupled to said front side of said outer wall of said housing having said back end being aligned with said vapor aperture, said front end being configured to be positioned proximate one of the user's eyes for directing the vapor into the user's eye thereby facilitating the user's eye to be moistened;
a cover being removably coupled to said housing for enclosing said reservoir, said cover being aligned with said well when said cover is removably coupled to said housing;
an on button being movably coupled to said housing, said on button being electrically coupled to said pump for turning said pump on;
an off button being movably coupled to said housing, said off button being electrically coupled to said pump for tuning said pump off; and
a power supply being removably positioned within said housing, said power supply being electrically coupled to said pump, said power supply comprising at least one battery.
